(19) United States
(12) Patent Application Publication
(10) Pub. No.: US 2010/0011443 A1
(43) Pub. Date: Jan. 14, 2010

(54) Method for preventing the spreading of malware via the use of a data security device

(76) Inventor: Shi-Ming Zhao, Jhudong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,181

(22) Filed: Jul. 2, 2009

Related U.S. Application Data
(60) Provisional application No. 61/079,139, filed on Jul. 9, 2008.

(51) Int. Cl. G06F 21/00; G06F 12/14

(52) U.S. Cl. 726/24

(57) ABSTRACT

Embodiments of the present invention set forth methods for preventing the spreading of malware via the use of a data security device. Specifically, one embodiment of the present invention sets forth a method, which includes the steps of activating a malware scanning engine in the data security device after the data security device is attached to a computer and a mobile device but before data communication between the computer and the mobile device occurs; invoke malware scanning engine before permitting any data communication between the mobile device and the computer to occur.

### BACKGROUND OF THE INVENTION

1. Field of the Invention

Embodiments of the present invention relate generally to techniques for guarding against malware and more specifically to a data security device for preventing the spreading of malware.

2. Description of the Related Art

Unless otherwise indicated herein, the approaches described in this section are not prior art to the claims in this application and are not admitted to be prior art by inclusion in this section.

As more and more mobile devices become susceptible to security breaches, they are also becoming a convenient channel to spread malware. The mobile device may be implemented as a program product for use with a computer system. The program(s) of the program product define functions of the embodiments (including the methods described herein) and can be contained on a variety of computer-readable storage media.

For example, a mobile device infected with one type of malware, a computer virus, can easily infect a computer after it is attached to it. Conversely, if the computer is already infected another computer virus, then it can also quickly infect the mobile device after the two systems are connected. In one conventional anti-virus solution, certain anti-virus software needs to be loaded onto at least the computer and also activated before the mobile device is attached to the computer. In another convention solution, at least the mobile device needs to be configured with certain anti-virus software to prevent the mobile device from becoming a carrier of unwanted malware. The aforementioned conventional approaches are costly, burdensome, and ineffective.

As the foregoing illustrates, what is needed is thus an improved mechanism to guard against the spreading of malware and address at least the problems discussed above.

### SUMMARY OF THE INVENTION

Embodiments of the present invention set forth methods for preventing the spreading of malware via the use of a data security device. Specifically one embodiment of the present invention sets forth a method, which includes the steps of activating a malware scanning engine in the data security device after the data security device is attached to a computer and a mobile device but before data communication between the computer and the mobile device occurs,further comprising;

a) after detecting a power-up event or a reset event, a suspend signal is asserted to the communication control circuit responsible for the mobile device port of the data security device; and

b) after the malware scanning engine is invoked, a resume signal is asserted to the communication control circuit to cause the communication between the mobile device and the computer to resume thus the data communication is then scanned by the malware scanning engine.

The data security device follows to obtain updates via a network connection of a computer, comprising:

a) after the malware scanning engine is invoked, the engine checks whether there is any update via network connection of a computer;

b) if update existed, it automatically downloads the necessary update and causes the update to be stores in the data security device; and

c) the data security device is configured to cause the malware scanning engine to be upgraded with the download update.

### BRIEF DESCRIPTION OF THE DRAWINGS

The accomplishment of this and other objects of the invention will become apparent from the following descriptions and its accompanying figures of which:

FIG. 1 illustrates how the data security device is connected to a mobile device and also a computer;

FIG. 2 is a conceptual diagram of a data security device configured to implement one or more aspects of the present invention;

FIG. 3 is a flow chart illustrating a process that the data security device is configured to follow;

FIG. 4 is a flow chart illustrating how the data security device suspends the data communication between the mobile device and the computer; and

FIG. 5 is a flow chart illustrating a process that the data security device follows to obtain updates via a network connection of the computer.

### DETAILED DESCRIPTION OF THE PREFERRED EMBODIMENT

The background information and the technical details set forth in Exhibit A, attached hereto, enable a person skilled in the art to implement one embodiment of the present invention to guard against the spreading of malware. A simplified block diagram of a data security device configured to perform one or more aspects of the present invention is also illustrated. One embodiment of the present invention includes among other things, at least the following features and functionalities:

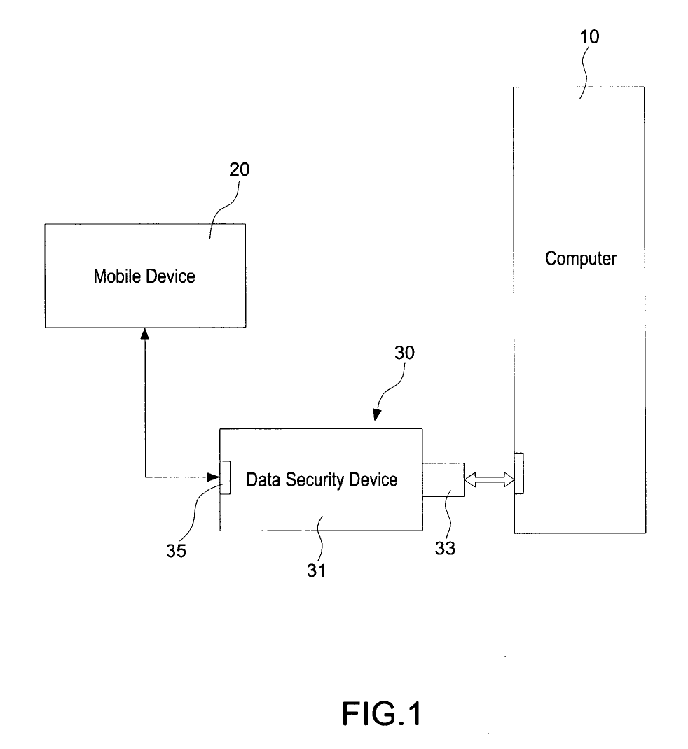

According to one embodiment of the present invention, FIG. 1 illustrates how this data security device 30 is connected to a mobile device 20 and also a computer 10. In one implementation, the connections adhere to the USB specification.

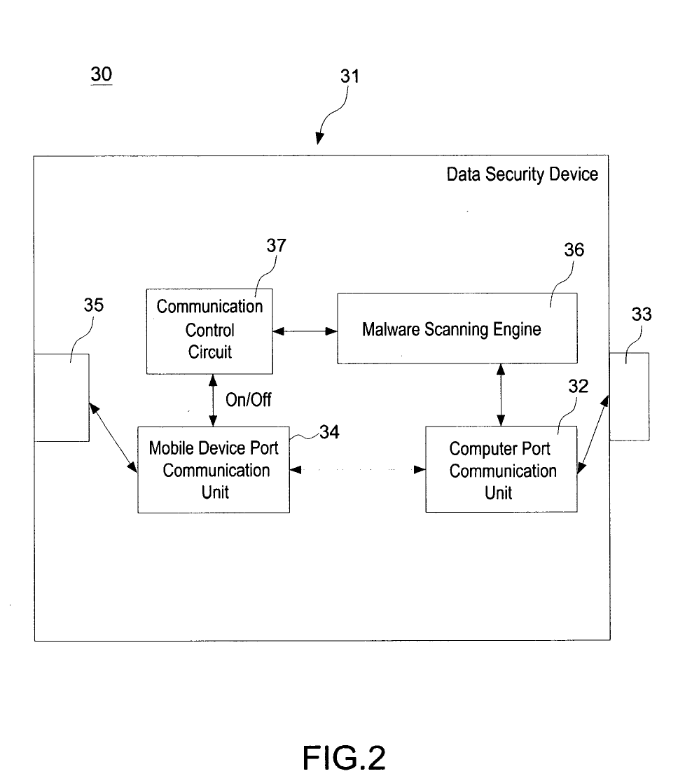

According to one embodiment of the present invention, FIG. 2 is a conceptual diagram of the data security device 30 configured to implement one or more aspects of the present invention. The data security device 30 comprises a case 31, a computer port communication unit 32, a plug 33, a mobile device port communication unit 34, a socket 35, a malware scanning engine 36, a communication control circuit 37,wherein the communication control circuit 37 connected to the mobile device port communication unit 34 and the malware scanning engine 36. The malware scanning engine 36 connected to the computer port communication unit 32 and the communication control circuit 37. The computer port communication unit 32 connects to the malware scanning engine 36 and the plug 33 therein. The mobile device port communication unit 34 connects to the socket 35 and the communication control circuit 37 therein.

The data security device 30 communicates to a computer 10 through the plug 33 and it communicates to a mobile device 20 through the socket 35. The communication control circuit 37 is configured to control the communication between the computer 10 and the mobile device 20.

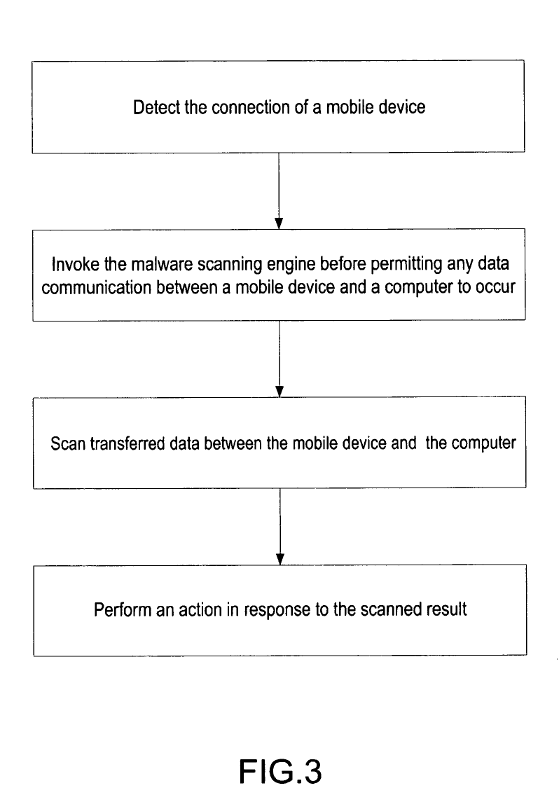

According to one embodiment of the present invention, FIG. 3 is a flow chart illustrating a process that the data security device is configured to follow. Specifically, the malware scanning engine in the data security device is invoked after the connection of the mobile device and the computer is detected. Before the malware scanning engine is activated, any data communication between the mobile device and the computer is suspended.

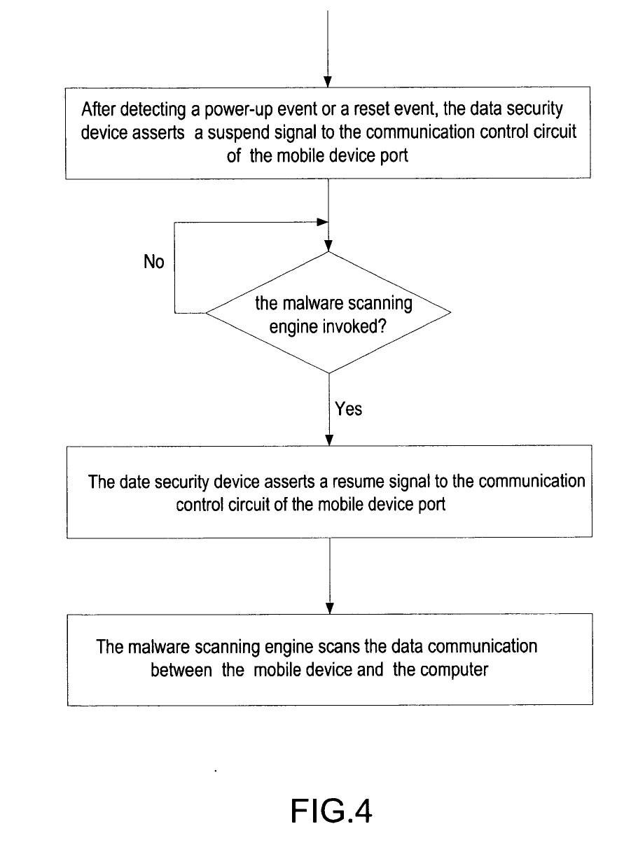

According to one embodiment of the present invention, FIG. 4 is a flow chart illustrating how the data security device suspends the data communication between the mobile device and the computer. Specifically, after detecting a power-up event or a reset event, a suspend signal is asserted to the communication control circuit responsible for the mobile device port of the data security device. The mobile device port of the data security device, in one implementation, is configured to connect to the mobile device. After the malware scanning engine is invoked, a resume signal is asserted to the communication control circuit to cause the communication between the mobile device and the computer to resume. This data communication is then scanned by the malware scanning engine.

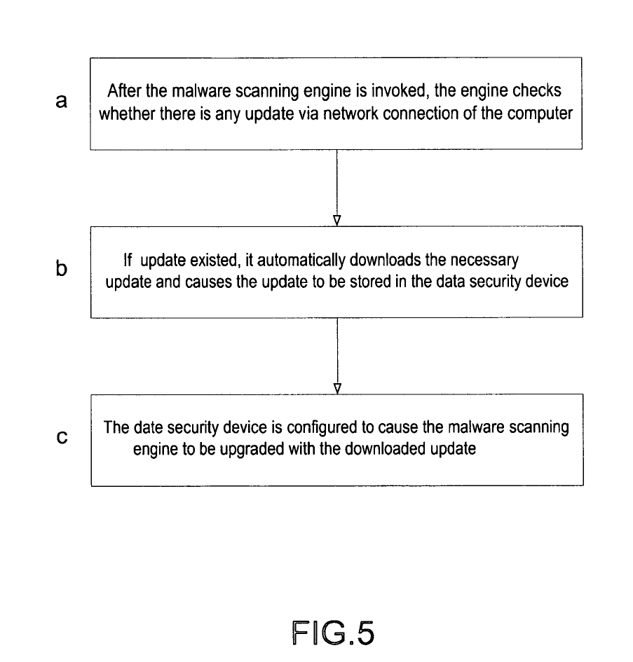

According to one embodiment of the present invention, FIG. 5 is a flow chart illustrating a process that the data security device follows to obtain updates via a network connection of the computer. After the malware scanning engine is invoked, the engine checks whether there is any update via the network connection of a computer. If update existed, it automatically downloads the necessary update and causes the update to be stored in the data security device. The data security device is configured to cause the malware scanning engine to be upgraded with the download update. This way, the malware scanning engine in the data security device can stay current and remain effective against newly introduced malware.

Therefore, the above examples, embodiments and drawings should not be deemed to be the only embodiments, and are presented to illustrate the flexibility and advantages of the present invention as defined by the following claims.

What is claimed is:

1. A method for preventing the spreading of malware via the use of a data security device, comprising:
activating a malware scanning engine in the data security device after the data security device is attached to a computer and a mobile device but before data communication between the computer and the mobile device occurs; invoke malware scanning engine before permitting any data communication between the mobile device and the computer to occur, further comprising;
a) after detecting a power-up event or a reset event, a suspend signal is asserted to the communication control circuit responsible for the mobile device port of the data security device; and
b) after the malware scanning engine is invoked, a resume signal is asserted to the communication control circuit to cause the communication between the mobile device and the computer to resume thus the data communication is then scanned by the malware scanning engine.

2. The method of claim 1, wherein the data security device follows to obtain updates via a network connection of a computer, comprising:
a) after the malware scanning engine is invoked, the engine checks whether there is any update via network connection of a computer;
b) if update existed, it automatically downloads the necessary update and causes the update to be stores in the data security device; and
c) the data security device is configured to cause the malware scanning engine to be upgraded with the download update.

3. The method of claim 1, wherein the data security device comprises:
a case, a computer port communication unit, a plug, a mobile device port communication unit, a socket, a malware scanning engine, and a communication control circuit;
wherein the communication control circuit connected to the mobile device port communication unit and the malware scanning engine; the malware scanning engine connected to the computer port communication unit and the communication control circuit; the computer port communication unit connects to the malware scanning engine and the plug therein; and the mobile device port communication unit connects to the socket and the communication control circuit therein.
